(19) United States
(12) Patent Application Publication
(10) Pub. No.: US 2025/0388147 A1
(43) Pub. Date: Dec. 25, 2025

(54) BACK FRAME

(71) Applicant: TOYOTA BOSHOKU KABUSHIKI KAISHA, Aichi (JP)

(72) Inventors: Yuya AKAI, Miyoshi-shi (JP); Kazuma OHARA, Seto-shi (JP)

(73) Assignee: TOYOTA BOSHOKU KABUSHIKI KAISHA, Aichi (JP)

(21) Appl. No.: 19/240,738

(22) Filed: Jun. 17, 2025

(30) Foreign Application Priority Data
Jun. 21, 2024 (JP) 2024-100258

(51) Int. Cl. B60N 2/68; B60N 2/22

(52) U.S. Cl. CPC B60N 2/682; B60N 2/22

(57) ABSTRACT

To provide a back frame of a vehicle seat. The back frame of the present disclosure includes a first side frame, a second side frame, an upper frame, a lower frame, a flange portion with a wall shape, extending toward the second side frame, the flange portion having a recessed portion recessed in a direction opposite to an extending direction from a distal end in the extending direction on a second side frame side, and a harness.

### CROSS-REFERENCE TO RELATED APPLICATIONS

The present application claims priority based on Japanese Patent Application No. 2024-100258 filed to Japanese Patent Office on Jun. 21, 2024, and the content of Japanese Patent Application No. 2024-100258 is incorporated by reference in its entirety.

### BACKGROUND

The present disclosure relates to a back frame of a vehicle seat.

For example, the back frame described in Japanese Unexamined Patent Application Publication No. 2022-167380 is a rectangular frame-shaped frame including two side frames, an upper frame, and a lower frame. The two side frames are frames extending in a vertical direction. The upper frame and the lower frame extend in a seat width direction and couple the two side frames.

### SUMMARY

The present disclosure discloses an example of a back frame in which an electric wire such as a harness is routed, and in the back frame, routing of the harness is considered.

A back frame of a vehicle seat desirably includes, for example, at least one of the following components. The components include a first side frame extending in a vertical direction, a second side frame disposed at a position shifted from the first side frame in a seat width direction, the second side frame extending in the vertical direction, an upper frame extending in the seat width direction and connecting an upper end side of the first side frame and an upper end side of the second side frame, a lower frame extending in the seat width direction and connecting a lower end side of the first side frame and a lower end side of the second side frame, a flange portion with a wall shape, provided on a rear end side of the first side frame, extending toward the second side frame, and having a recessed portion recessed in a direction opposite to the extending direction from a distal end in the extending direction, and a harness routed at a position close to the recessed portion.

In the back frame, the interference between the harness and the first side frame can be easily avoided. In this case, the assembly worker can easily assemble the harness to the back frame.

The back frame may have, for example, the following configuration. The back frame desirably includes an attachment portion provided in the flange portion and to which another component is attached.

When a virtual line passing through a bottom of the recessed portion and parallel to an extending direction of the first side frame is defined as a former distal end line, at least a part of the attachment portion desirably overlaps the former distal end line.

The other component is desirably a cushion body obtained by integrating a seat pad, a skin portion, and an attached portion to be attached to the attachment portion.

### BRIEF DESCRIPTION OF THE DRAWINGS

An example embodiment of the present disclosure will be described below with reference to the accompanying drawings, in which:

FIG. 1 is a diagram illustrating a back frame according to a first embodiment;

FIG. 2 is a diagram illustrating the back frame according to the first embodiment;

FIG. 3 is a diagram illustrating an electric motor portion of the back frame according to the first embodiment;

FIG. 4 is a diagram illustrating the electric motor portion of the back frame according to the first embodiment;

FIG. 5 is a diagram illustrating the back frame and a side cushion body according to the first embodiment; and

FIG. 6 is a diagram illustrating the back frame and the side cushion body according to the first embodiment.

### DETAILED DESCRIPTION OF EXEMPLARY EMBODIMENTS

The following embodiments of the present invention illustrate examples of embodiments falling within the technical scope of the present disclosure. That is, the matters specifying the invention and the like described in the claims are not limited to the specific configurations, structures and the like described in the following embodiments.

The present embodiment is an example of a back frame of a seat (hereinafter, referred to as vehicle seat) mounted on a vehicle such as an automobile. Arrows indicating directions, oblique lines, and the like attached to the individual drawings are described in order to facilitate understanding of the relationship between the individual drawings, the shape of members or portions, and the like.

The back frame is not limited to the directions illustrated in the drawings. The directions illustrated in the individual drawings are directions in a state where the vehicle seat is assembled to a vehicle. The view with oblique lines does not necessarily show a cross-sectional view.

At least one member or portion described with at least a reference sign is provided unless otherwise noted such as “only one”. That is, when there is no description such as “only one”, two or more members may be provided. The back frame disclosed in the present disclosure includes at least one of components such as members or portions described with at least reference signs and structural portions shown in the drawings.

### First Embodiment

### <1. Outline of Back Frame>

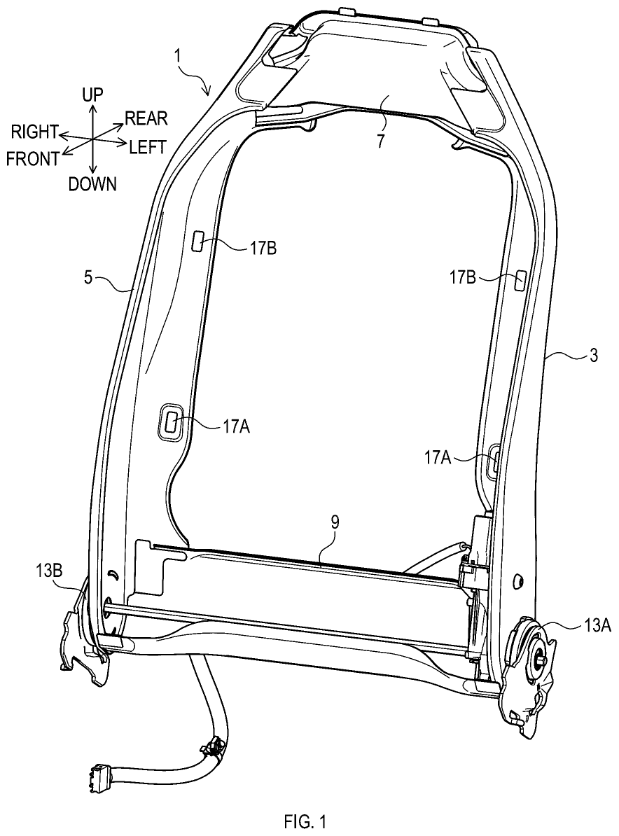

As illustrated in FIG. 1, a back frame 1 is a substantially rectangular frame-shaped frame constituting the framework of a seat back. The seat back supports the back of a sitter. The back frame 1 is rotatably coupled to the rear end side of a cushion frame (not illustrated).

The back frame 1 includes a first side frame 3, a second side frame 5, an upper frame 7, and a lower frame 9. The first side frame 3 and the second side frame 5 are strength members extending substantially in the vertical direction.

The second side frame 5 is disposed at a position shifted from the first side frame 3 in a seat width direction. The upper frame 7 is a strength member extending in the seat width direction and connecting the upper end side of the first side frame 3 and the upper end side of the second side frame 5.

The lower frame 9 is a strength member extending in the seat width direction and connecting the lower end side of the first side frame 3 and the lower end side of the second side frame 5. The first side frame 3, the second side frame 5, the upper frame 7, and the lower frame 9 are made of metal, and the frames are joined by laser welding.

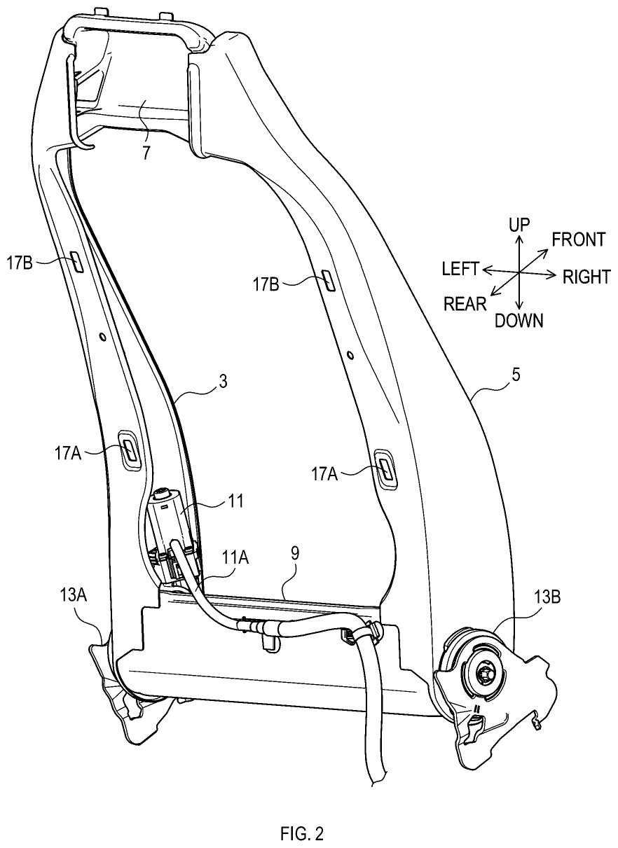

As illustrated in FIG. 2, an electric motor 11 is provided on the lower end side of the first side frame 3. The electric motor 11 supplies rotational force to recliners 13A and 13B. The recliners 13A and 13B rotatably couple the back frame 1 to the cushion frame.

When the electric motor 11 is operated, the back frame 1 is rotationally displaced in a seat longitudinal direction with respect to the cushion frame about the recliners 13A and 13B. The electric motor 11 is fixed to the first side frame 3.

### <2. Detailed Configuration of Side Frame and the Like>

The shape of the first side frame 3 and the shape of the second side frame 5 are substantially line-symmetric with respect to a virtual line passing through the center in the seat width direction. The following description relates to the first side frame 3.

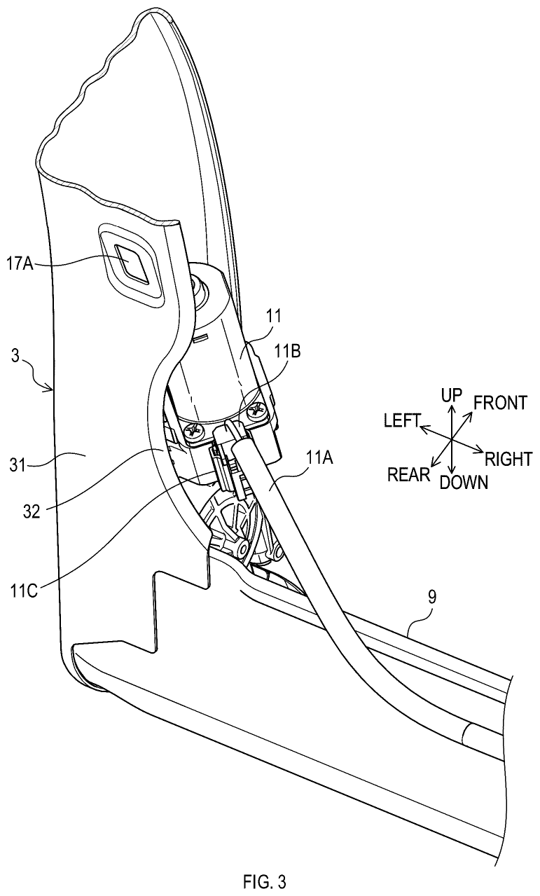

As illustrated in FIG. 3, a flange portion 31 is provided on the rear end side of the first side frame 3. The flange portion 31 is a wall-like portion extending from the rear end side toward the second side frame 5 (in the present embodiment, to the right side).

The cross-sectional shape of the first side frame 3 is a substantially L-shape or a substantially C-shape. A recessed portion 32 is provided at the distal end (in the present embodiment, the right end) of the flange portion 31 in the extending direction and in the vicinity of the electric motor 11.

The recessed portion 32 is a recess recessed in the direction opposite to the extending direction of the flange portion 31 (in the present embodiment, to the left). A harness 11A is routed at a position close to the recessed portion 32. The harness 11A is an electric wire or the like that supplies electric power to the electric motor 11.

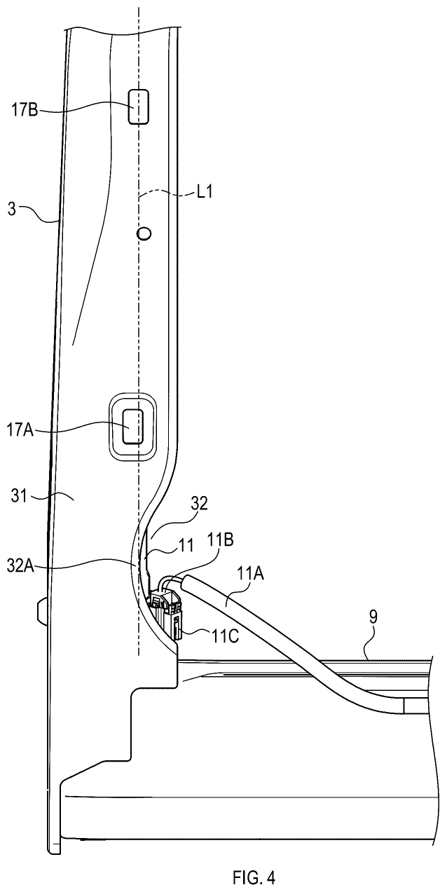

An end portion of the harness 11A is electrically connected to a connector 11C of the electric motor 11 via a connector 11B. As illustrated in FIG. 4, at least parts of the connector 11B and the connector 11C overlap the recessed portion 32.

At least parts of the connector 11B and the connector 11C projected on a virtual plane (in this example, the sheet surface of FIG. 4) orthogonal to the seat longitudinal direction overlap the projected recessed portion 32 so as to be located in the recessed portion 32 projected on the projection plane.

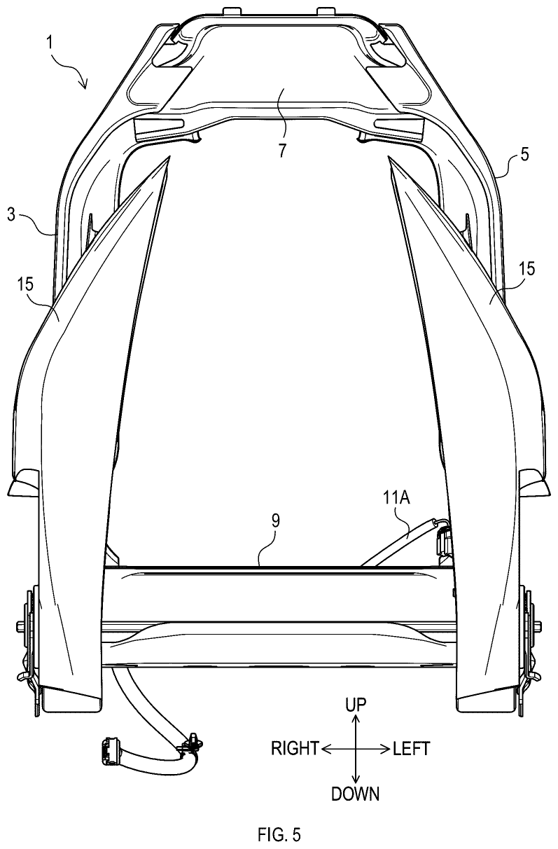

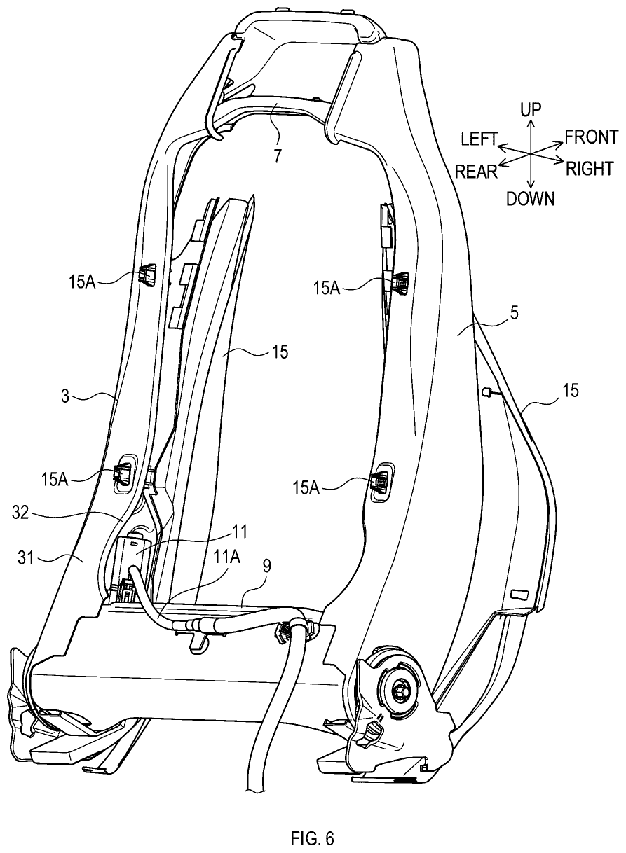

The first side frame 3 includes attachment portions 17A and 17B. The attachment portions 17A and 17B are portions to which attached portions 15A (see FIG. 6) of a side cushion body 15 (see FIG. 5) area attached.

The side cushion body 15 constitutes a cushion portion on the end portion side in the width direction of the seat back. The side cushion body 15 is formed by integrating a seat pad, a skin portion, and the attached portion 15A.

As illustrated in FIG. 4, at least parts of the attachment portions 17A and 17B overlap a former distal end line L1. The former distal end line L1 is a virtual line that passes through a bottom 32A of the recessed portion 32 and is substantially parallel to the extending direction of the first side frame 3. The bottom 32A refers to a position of the recessed portion 32 farthest from the second side frame 5.

### <3. Characteristics of Back Frame>

The flange portion 31 provided on the rear end side of the first side frame 3 includes the recessed portion 32 recessed in the direction opposite to the extending direction from the distal end in the extending direction (see FIG. 4).

As a result, in the back frame 1, the interference between the harness 11A and the first side frame 3 can be easily avoided. In this case, the assembly operator can easily connect the connector 11B and the connector 11C.

The flange portion 31 extends to a position beyond the former distal end line L1 except for the recessed portion 32 (see FIG. 4). As a result, the joint area of the first side frame 3 and the lower frame 9 can be increased. In this case, the first side frame 3 and the lower frame 9 can be firmly joined.

### OTHER EMBODIMENTS

The harness 11A according to the embodiment described above is a harness connected to the electric motor 11. However, the present disclosure is not limited thereto. For example, the harness may be connected to a seat air conditioner.

In the embodiment described above, the side cushion body 15 is “another component” to be attached to the attachment portions 17A and 17B. However, “another component” attached to the attachment portions 17A and 17B according to the present disclosure may be a component other than the side cushion body 15.

In the embodiment described above, the first side frame 3 and the second side frame 5 include the recessed portion (see FIG. 2). However, the present disclosure is not limited thereto. For example, the recessed portion 32 may be provided at least at a position close to the electric motor 11.

In the embodiment described above, at least parts of the attachment portions 17A and 17B overlap the former distal end line L1. However, the present disclosure is not limited thereto. For example, the former distal end line L1 may be located on the side of the attachment portions 17A and 17B closer to the second side frame 5, or the former distal end line L1 may be located on the side of the attachment portions 17A and 17B opposite to the second side frame 5.

In the embodiment described above, the vehicle seat according to the present disclosure is applied to a vehicle. However, the application of the invention disclosed herein is not limited thereto. For example, the present invention can also be applied to seats used for vehicles such as railway vehicles, ships, and aircrafts, and stationary seats used in theaters, homes, and the like.

Furthermore, the present disclosure is not limited to the embodiments described above as long as it meets the gist of the disclosure described in the embodiments. Therefore, a configuration in which at least two of the plurality of embodiments described above are combined, or a configuration in which any of the components illustrated in the drawings or the components described with reference signs in the embodiments is eliminated may be used.

What is claimed is:

1. A back frame of a vehicle seat comprising:
a first side frame extending in a vertical direction;
a second side frame disposed at a position shifted from the first side frame in a seat width direction, the second side frame extending in the vertical direction;
an upper frame extending in the seat width direction and connecting an upper end side of the first side frame and an upper end side of the second side frame;
a lower frame extending in the seat width direction and connecting a lower end side of the first side frame and a lower end side of the second side frame;
a flange portion with a wall shape, provided on a rear end side of the first side frame, extending toward the second side frame, and having a recessed portion recessed in a direction opposite to the extending direction from a distal end in the extending direction; and
a harness routed at a position close to the recessed portion.

2. The back frame according to claim 1, further comprising an attachment portion provided in the flange portion and to which another component is attached.

3. The back frame according to claim 2, wherein when a virtual line passing through a bottom of the recessed portion and parallel to an extending direction of the first side frame is defined as a former distal end line,
at least a part of the attachment portion overlaps the former distal end line.

4. The back frame according to claim 3, wherein the other component is a cushion body obtained by integrating a seat pad, a skin portion, and an attached portion to be attached to the attachment portion.
